(19) United States
(12) Patent Application Publication
(10) Pub. No.: US 2008/0307973 A1
(43) Pub. Date: Dec. 18, 2008

(54) Single Stage Electrostatic Precipitator

(76) Inventor: Roger Gale, Oslo (NO)

Correspondence Address: WENDEROTH, LIND & PONACK, L.L.P., 2033 K STREET N. W., SUITE 800, WASHINGTON, DC, 20006-1021, US

(21) Appl. No.: 12/084,199

(22) PCT Filed: Oct. 17, 2006
(86) PCT No.: PCT/NO2006/000378

§ 371 Date: Jul. 31, 2008

(30) Foreign Application Priority Data
Nov. 1, 2005 (NO) 2005 5113

(51) Int. Cl. B03C 3/12

(52) U.S. Cl. 96/77

(57) ABSTRACT

In an electrostatic precipitator for filtering particulate matter from a gas, a fan (10) draws the gas (5) through an ioniser section (7) and a collector section (6). Ioniser blades (3) with sawtooth spikes (8) create a corona discharge (4) when charged to a high voltage, so that gas-borne particles are charged when passing through the corona area. The collector section (6) consists of a set of metallic plates (1, 2) of which every other plate (1) is connected to ground, while the remaining plates (2) receive a charge by induction from the ioniser blades (3), and act as repeller plates, pushing charged particles in the gas flow (5) over to the grounded plates (1).

### TECHNICAL FIELD

The present application relates to apparatus for filtering particulate matter from gasses and more particularly to electrostatic filters which are adapted to remove particles by charging gas-borne particles by means of an ioniser arrangement and thereafter precipitating the charged particles in a collector section with differently charged parallel plates. Typically these filters will be used to remove particulate from air streams.

### BACKGROUND ART

The prior art includes filters using the principle of electrostatics for removing particles from various gasses; normally air, at velocities up to 10 m/s. The principle here employed is as follows. The air is propelled through an electric field where particles in the air receive an electric charge. The charged particles move into a collector section where each alternate plate is charged with the same polarity as the particles, and repels them. The other set of plates are grounded, which collect the particles. The remaining air, cleaned of the majority of particles, is then re-introduced into the environment. Washing cleans the contaminated plates, normally by water/detergent, high-pressure air or other means. The particles can be charged positively or negatively depending on the environment and the location of the filter.

While the electrostatic filter has evolved over the years there remain two basic operational problems. In the event of the filter collector section being shorted out or electrically discharging, the ioniser loses its charge. When this happens, the filter loses the ability to collect particulate for the time that the ioniser is discharged. In the event that the collector section is shorted, then the collector, ioniser and associated filter cells are discharged and fail to collect particulate matter.

### SUMMARY OF THE INVENTION

Accordingly, it is the object of this invention to provide an improved electrostatic filter for the filtering of gaseous borne particulate.

It is another object of this invention to provide an improved electrostatic filter, which may be easily assembled.

It is a further object of this invention to provide an improved electrostatic filter, which may be easily tested for proper assembly.

It is still another object of this invention to provide an improved electrostatic filter whose elements are not easily broken.

It is yet another object of this invention to provide an improved electrostatic filter, which may be installed with cost savings.

It is another object of the invention to make an electrostatic filter function with little maintenance.

The above mentioned objects are obtained by the provision of an apparatus such as defined in the appended independent claim 1. Favourable embodiments of the invention appear from the dependent claims.

### BRIEF DESCRIPTION OF THE DRAWINGS

FIG. 1 is a side view of one ioniser blade.

FIG. 2 is a side view of an induction-powered cell, showing generally the upstream ioniser blades and the downstream collector section.

FIG. 3 is a plan view showing an embodiment of the apparatus in accordance with the invention.

FIG. 4 shows a complete apparatus including a fan.

### DETAILED DESCRIPTION OF THE INVENTION

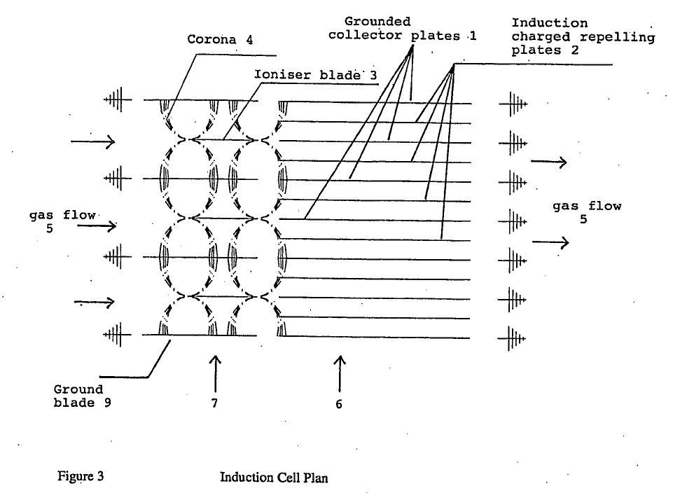

Referring to FIG. 3, which shows a preferred embodiment of the invention schematically, the electrostatic filter utilises a series of parallel flat conduction plates 1, 2 and flat ‘saw tooth’ ioniser blades 3 (with sharp teeth 8) standing parallel to and in front of the conduction plates 1,2. The flat ‘saw tooth’ ioniser blades 3 are placed so that they are lying in the same plane as some of the conduction plates 1,2. The ioniser blades 3 are charged to a high potential typically greater than 11000 volts DC. The ioniser blades 3 have such a width, in the direction of gas flow 5, that they induce a voltage in some 2 of the parallel conduction plates. The parallel conduction plates 2 are not electrically connected to a power supply. The ioniser blades 3 and complementary ground blades 9 constitute together an ioniser section 7. The ground blades 9 are arranged substantially between and parallel to the ioniser blades 3 for assisting in providing a corona discharge 4 from the ioniser blades 3 when a high voltage is applied thereto. Due to the design of the ioniser section 7 the parallel conduction plates 2 are charged to a high DC voltage by induction. The amount of this charge depends on the design of the ioniser and the distance to the collector section 6.

As particles pass through the corona 4, they are given a charge, which has the same potential as that of the ioniser blades 3. As the particles pass into the collector section 6, the conduction plates 2 have the same induced charge as the particles. This has the effect of repelling the particles towards the conduction plates 1 that are connected to ground. When the particles come into contact with the ground conduction plates 1, the ground conduction plates 1 hold the particles.

The filter cell 6, 7 has an ionising charge on its ioniser blades 3. This induces a, charge in some of the plates 2 in the collector section 6 of the cell. Should the collector discharge, then only that particular cell is affected. Should one set of collector/ground plates be shorted to ground, then only this part of the cell is affected and the ionising part continues to charge the particles as they move through the corona. Some of these particles then pass into the shorted section of the collector. In this part both plates are at ground. Therefore both plates will attract particles, which come within the field of attraction. In the rest of the collector section, operation may continue unaffected.

All plates and blades are conductive, preferably made of a metal.

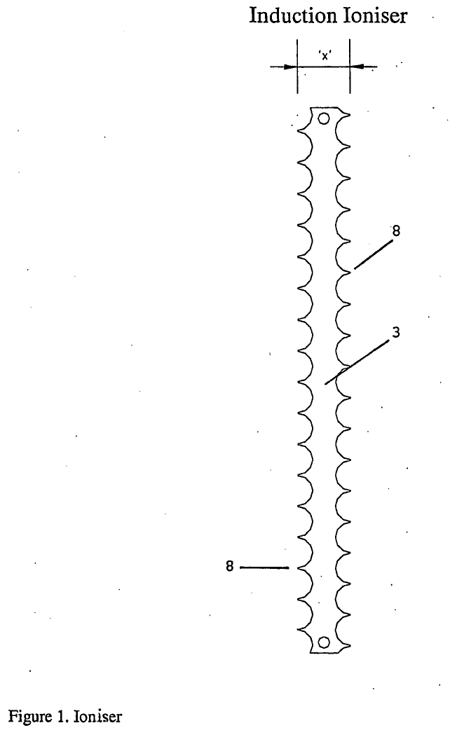

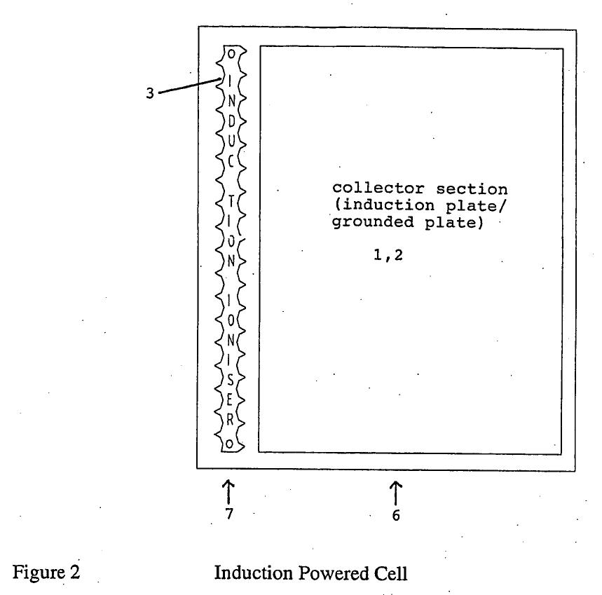

The ioniser blade shown in FIG. 1 is scalloped, and the width is such that the rear spikes induce a voltage in non-connected plates in the collector section. FIG. 2 shows the relative position of the ioniser in relation to the collector plate. The distance between the ioniser blade and the collector section plates is important in determining the induced voltage. In FIG. 3 the earth can be either negative or positive. The ionising voltage can be either negative or positive but it is to be the opposite of the earth. The earth plates 1 and induction plates 2 are separated electrically so that they are independent of one another.

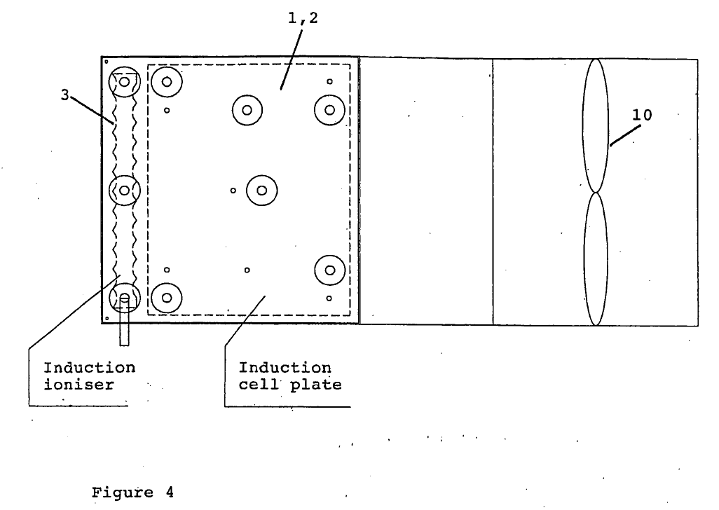

In FIG. 4 appears the arrangement of a fan 10 for sucking gas with particles through the filter sections, first the ioniser section with a set of induction ioniser blades 3 and ground blades 9, and then through the collector section that contains alternate earth contact plates 1 and induction cell plates 2. The Induction ioniser blades 3 have a high voltage, which causes a corona discharge 4. The corona discharge contacts the induction cell plate 2. The corona creates a voltage in the cell plate 2. The cell plate 2 is isolated from the cell earth. This isolation causes the induction cell plate 2 to act as a capacitor. The induction effect also causes any charged particle to be repelled from the plate 2. This particle is then forced over to the earth contact plate 1. This earth contact plate 1 is connected to earth electrically.

So, every other plate 1 in the collector section 6 is connected to ground, while the remaining collector plates 2 are without any electrical connection. Preferably, each ioniser blade 3 lies substantially in the same plane as a grounded collector plate 1. Preferably, the ground blades 9 in the ioniser section 7 lie substantially in the same planes as every other grounded collector plate 1, while the non-connected remaining plates 2 for inductive charging in the collector section 6 lie in alternate planes between the planes defined by the ioniser blades 3 and the ground blades 9.

Preferably, the ioniser blades 3 are supported by stays that act at the same time as electrical conductors for high voltage to the blades 3.

The system uses a high ionising voltage to induce a voltage in the collector section. The size of the collecting voltage depends on the depth of the ioniser and size of the voltage. A 50 mm ioniser gives say 4 kV, while a 65 mm ioniser gives 6 kV for the same ionising voltage.

The filter apparatus of the patent invention is tolerant to having water in contact with the collector section without damage to the filter or the collector section. Further, the inventive filter apparatus is more economical to use than non-induction voltage filters. The filter apparatus of the invention requires less maintenance than non-induction voltage filters. Also, on being discharged to earth, the filter apparatus does not affect other cells which can be connected electrically to the ioniser section of the discharged cell. And, importantly, the filter apparatus still retains the ability to remove particles from the air even when the collector section is discharged to earth.

1. Apparatus for filtering particulate matter from a gas (5), comprising
a collector section (6) comprising a plurality of parallel conduction plates (1, 2), for receiving electrically charged particles borne by a flow (5) of said gas,
upstream of said collector section (6) an ioniser section (7), comprising a set of conductive ioniser blades (3) parallel to said conductive plates (1, 2) and each having a high number of sharp teeth (8) at least along its edges, in sawtooth fashion, as well as ground blades (9), and
a fan (10) for drawing said gas through said ioniser section (7) and said collector section (6),
characterized in that every other conductive plate (1) in said collector section (6) is connected to ground while the remaining plates (2) are without any electrical connection, said remaining plates (2) thereby being arranged to be charged electrically by induction from said ioniser blades (3) when these blades (3) are charged to a high voltage.

2. The apparatus of claim 1,
characterized in that the ioniser blades (3) are supported by stays that act at the same time as electrical conductors for high voltage to the blades (3).

3. The apparatus of claim 1,
characterized in that said ground blades (9) in said ioniser section (7) are arranged substantially between and parallel to said ioniser blades (3), for assisting in providing a corona discharge (4) from said ioniser blades (3) when a high voltage is applied thereto.

4. The apparatus of claim 3,
characterized in that each ioniser blade (3) lies substantially in the same plane as a grounded collector plate (1).

5. The apparatus of claim 4,
characterized in that said ground blades (9) lie substantially in the same planes as every other grounded collector plate (1), the non-connected remaining plates (2) for inductive charging in the collector section (6) thereby lying in alternate planes between the planes defined by said ioniser blades (3) and said ground blades (9).
